(19) United States
(12) Patent Application Publication
(10) Pub. No.: US 2012/0258835 A1
(43) Pub. Date: Oct. 11, 2012

(54) REDUCTION GEAR

(75) Inventors: Yuya KATAOKA, Chino (JP); Satoshi KINOSHITA, Matsumoto (JP); Hiroyuki KUSUMOTO, Suwa (JP)

(73) Assignee: SEIKO EPSON CORPORATION, Tokyo (JP)

(21) Appl. No.: 13/441,387

(22) Filed: Apr. 6, 2012

(30) Foreign Application Priority Data
Apr. 8, 2011 (JP) 2011-086073

(51) Int. Cl. F16H 1/32; F16H 55/16

(52) U.S. Cl. 475/178; 475/180

(57) ABSTRACT

A reduction gear includes an outer circumference internally toothed gear having first teeth; and an inner circumference externally toothed gear having a second teeth. The reduction gear relatively rotates while the first teeth and the second teeth engage each other. At least one of the first and second teeth has an elastic structure inside the tooth so that the tooth is elastically deformable.

### BACKGROUND

1. Technical Field

The present invention relates to a reduction gear.

2. Related Art

JP-A-5-296301 discloses a technique for eliminating reduction gear backlash. In this technique an outer circumference internal tooth gear is formed as a two-stage gear, and the stages are relatively twisted so that backlash between a fixed sun inner circumference gear and a planetary gear, and between a pin and a pin hole, is regulated.

JP-A-4-254045 discloses another technique for eliminating reduction gear backlash. In this technique, as shown in FIGS. 8A and 8B, each gear tooth is formed with a flexible section along one surface which comes into contact with and engages another gear. Accordingly, it is possible to eliminate backlash among the teeth.

However, in the technique for eliminating backlash disclosed in JP-A-5-296301, the ability to regulate the amount of clearance among the teeth is constant and fixed. The clearance is varied by the position of the planetary gear due to influences such as the engagement between the fixed sun inner circumference gear and the planetary gear, the precision of the output transmission holes and the like. Thus, in a strict sense, it is not possible to entirely eliminate backlash.

In addition, in the technique for eliminating backlash disclosed in JP-A-4-254045, backlash is only partly eliminated. This is because an elastic structure is included on only one side of the tooth. As such, when the rotation direction switches, the output response varies.

Thus, a reduction gear that can reduce backlash regardless of the rotation direction is required.

### SUMMARY

An advantage of some aspects of the invention is to solve at least a part of the problems described above, and the invention can be implemented in the following forms or application examples.

### Application Example 1

This application example is directed to a reduction gear including an outer circumference internal tooth gear having a first tooth; and an inner circumference external tooth gear having a second tooth, wherein the reduction gear relatively rotates while the first tooth and the second tooth engage each other, and at least one of the first tooth and the second tooth has an elastic structure inside the tooth and the tooth is elastically deformable.

In this application example, at least one tooth of the inner circumference external tooth gear and the outer circumference internal tooth gear has an elastic structure inside the tooth. Accordingly, the tooth shape is capable of being elastically deformed and therefore backlash between the teeth is capable of being eliminated. Since the elastic structure is inside the center of the tooth, it is possible to prevent backlash regardless of the rotation direction.

### Application Example 2

In the reduction gear of the above application example, it is preferable that the inner circumference external tooth gear has an eccentric mechanism and the eccentric mechanism has a regulation mechanism regulating an amount of the eccentricity that is a distance between a center of a circumference where the first tooth is arranged and a center of a circumference where the second tooth is arranged.

In this application example, since the eccentric mechanism of the inner circumference external tooth gear has the regulation mechanism of the amount of the eccentricity, the degree of mating between the first tooth and the second tooth may be regulated. Accordingly, it is possible to absorb variations in the shape of the amount of adjustment of the inner circumference external tooth gear and the outer circumference internal tooth gear caused by reasons of manufacturing.

### Application Example 3

In the reduction gear of the above application example, it is preferable that the inner circumference external tooth gear have output transmission holes, the reduction gear further have an output shaft where output transmission fixing pins that come into contact with the output transmission holes are arranged, and the regulation mechanism regulates a clearance between the output transmission fixing pins and the output transmission holes.

According to this application example, the regulation mechanism regulates the clearance between the output transmission fixing pins and the output transmission holes. Accordingly, the reduction gear is capable of decreasing the backlash.

### Application Example 4

In the reduction gear of the above application example, it is preferable that all of the output transmission fixing pins come into contact with the output transmission holes.

According to this application example, all of the output transmission fixing pins are capable of contributing to the torque transmission. Accordingly, when the output transmits, it is possible to disperse the load on the output transmission fixing pins.

### BRIEF DESCRIPTION OF THE DRAWINGS

The invention will be described with reference to the accompanying drawings, wherein like numbers reference like elements.

FIG. 1A is a schematic front view illustrating a structure of a reduction gear according to a first embodiment, and FIGS. 1B and 1C are enlarged schematic views of the teeth of the reduction gear.

FIG. 2A is a schematic front view illustrating a state where the gears are engaged with pressure applied, and

FIGS. 2B and 2C are enlarged schematic views of the reduction gear teeth in this state.

FIG. 3 is a schematic front view illustrating a first state of a regulation mechanism for regulating an amount of eccentricity in an eccentric mechanism of an inner circumference external tooth gear according to a second embodiment.

FIG. 4 is a schematic front view illustrating a second state of the regulation mechanism for regulating an amount of eccentricity in an eccentric mechanism of the inner circumference external tooth gear.

FIG. 5 is a schematic cross-sectional view illustrating a configuration of a regulation mechanism.

FIG. 6 is a schematic side cross-sectional view illustrating a configuration of a reduction gear.

FIG. 7 is a schematic perspective view illustrating a cased reduction gear.

FIGS. 8A and 8B are schematic views illustrating a structure of a tooth according to the related art.

### DESCRIPTION OF EXEMPLARY EMBODIMENTS

Hereinafter, embodiments of the invention will be described with reference to the drawings. The scale of each member in the drawings may be altered from reality in order to make each member recognizable.

### First Embodiment

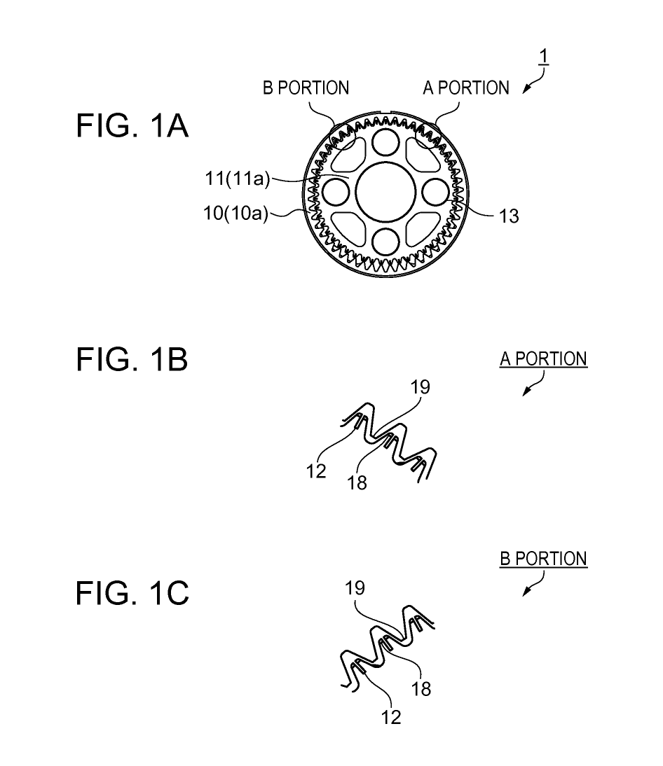

FIG. 1A is a schematic front view illustrating a structure of a reduction gear according to a first embodiment.

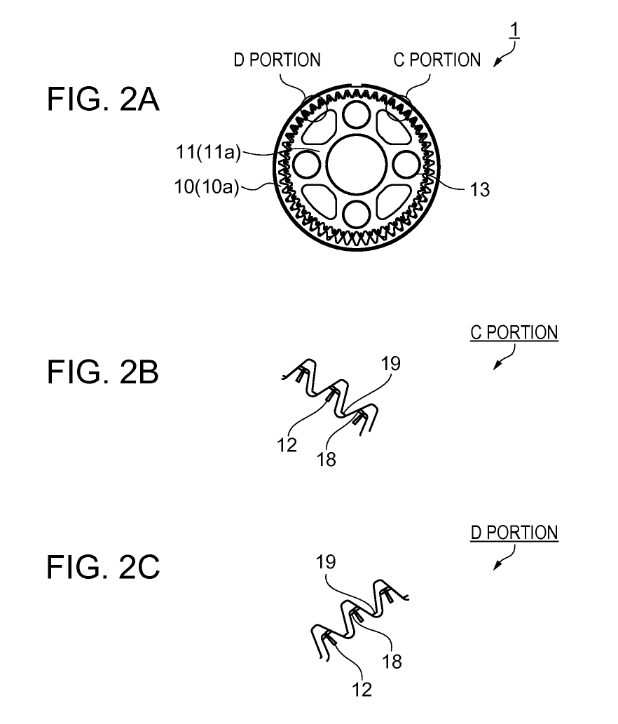

FIGS. 1B and 1C are enlarged schematic views of the teeth of the reduction gear. FIG. 1B is an enlarged view of A portion in FIG. 1A and FIG. 1C is an enlarged view of B portion in FIG. 1A. FIG. 2A is a schematic front view illustrating a state where the gears are engaged with pressure applied. FIGS. 2B and 2C are enlarged schematic views of the reduction gear teeth in this engaged state. FIG. 2B is an enlarged view of C portion in FIG. 2A and FIG. 2C is an enlarged view of D portion in FIG. 2A. First, a schematic configuration of the reduction gear as a reduction device according to the first embodiment will be described.

As shown in FIGS. 1A to 1C, a reduction gear 1 of this embodiment includes an inner circumference external tooth gear 11 (an externally toothed inner ring gear) and an outer circumference internal tooth gear 10 (an externally toothed outer ring gear). The inner circumference external tooth gear 11 includes an external tooth gear main body 11a, and second teeth 18. At least one second tooth 18 of the inner circumference external tooth gear 11 has an elastic structure 12. The outer circumference internal tooth gear 10 includes an internal tooth gear main body 10a having a circular or arc shape and first teeth 19 that project toward the center of the arc. There are fewer second teeth 18 than first teeth 19. Thus, the second teeth 18 of the inner circumference external tooth gear 11 engage with the first teeth 19 of the outer circumference internal tooth gear 10 and shakes while reducing the speed of an input thereof by the difference in the number of teeth.

A flexible or elastic structure 12 in the center of at least one second tooth 18 of the inner circumference external tooth gear 11 leaves a notch, a through hole or the like at the center of the second tooth 18 and a cavity is included inside the tooth so that the structure thereof has elasticity. The outer circumference internal tooth gear 10 is an internally toothed gear engaging with the inner circumference external tooth gear 11. As shown in FIGS. 2A to 2C, when the second tooth 18 of the inner circumference external tooth gear 11 engages with the first tooth 19 of the outer circumference internal tooth gear 10 with pressure applied to the first tooth 19, the tooth shape of the second tooth 18 is changed by elastic deformation. At this time, in the C portion illustrated in FIG. 2B, a surface of the second tooth 18 on the left side in the drawing and a surface of the first tooth 19 on the right side are pressed against each other and the second tooth 18 is compressed. Meanwhile, in the D portion illustrating in FIG. 2C, a surface of the second tooth 18 on the right side in the drawing and a surface of the first tooth 19 on the left side are pressed against each other and again the second tooth is compressed. Accordingly, the outer circumference internal tooth gear 10 is pinched with the inner circumference external tooth gear 11. As a result, even when the outer circumference internal tooth gear 10 and the inner circumference external tooth gear 11 relatively rotate to the right, or to the left (i.e., clockwise or counter clockwise), the rotation can be performed without clearance between the first tooth 19 and the second tooth 18.

According to the reduction gear 1 described above, at least the following advantages can be obtained. Since the second tooth 18 and the first tooth 19 are engaged without clearance, the reduction gear 1 is capable of eliminating backlash. In addition, since a tooth tip cavity is formed at the center of the tooth, the rotation can be smoothly performed without backlash in either rotating directions. When the rotation direction is switched, the output response does not vary.

It should be noted that the elastic structure 12 included in the inner circumference external tooth gear 11 may have an elastic member such as resin instead of an empty cavity. In addition, the outer circumference internal tooth gear 10 may have the elastic structure 12 instead of the inner circumference external tooth gear 11. Further, both the outer circumference internal tooth gear 10 and the inner circumference external tooth gear 11 may have the elastic structure 12.

### Second Embodiment

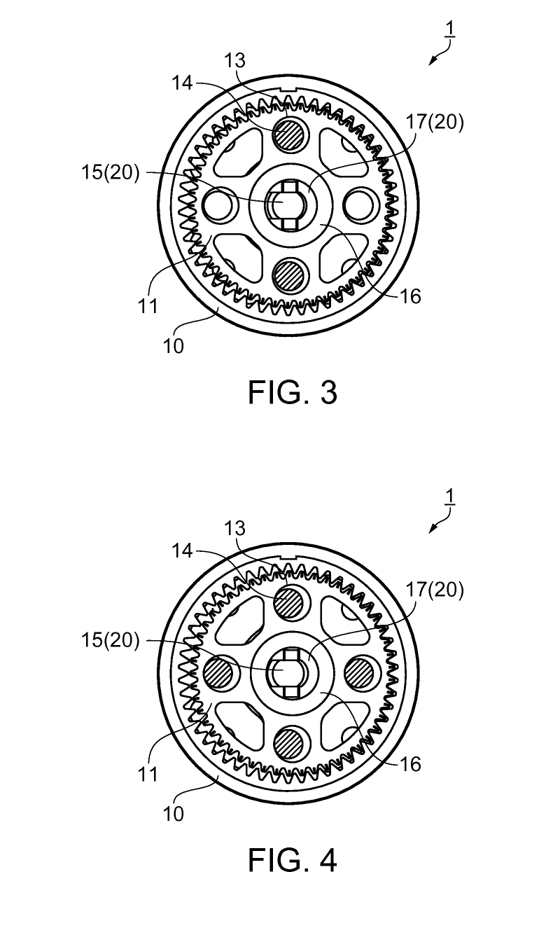

FIGS. 3 and 4 are schematic front views illustrating two states of a regulation mechanism for regulating the amount of eccentricity in an eccentric mechanism of the inner circumference external tooth gear according to a second embodiment. FIG. 3 illustrates a state before the regulation mechanism regulates the amount of eccentricity. FIG. 4 illustrates a state after the regulation mechanism regulates the amount of eccentricity. The regulation mechanism will be described with reference to FIGS. 3 and 4. However, no duplicate description of the configurations and portions that are the same as the first embodiment will be provided.

As shown in FIG. 3, the inner circumference external tooth gear 11 has an eccentric mechanism 17. The eccentric mechanism 17 includes a regulation mechanism 20 for regulating the amount of eccentricity. The outer circumference internal tooth gear 10 has the first teeth 19 arranged along the circumference of a circle and the inner circumference external tooth gear 11 has the second teeth 18 arranged along the circumference of another circle. Thus, the difference between the center positions of the circles is referred to as the amount of eccentricity. The regulation mechanism 20 includes an input shaft 15 and the eccentric mechanism 17. A bearing 16 surrounds the regulation mechanism 20 and the regulation mechanism 20 is located at the center of the inner circumference external tooth gear 11.

The input shaft 15 receives input from the reduction gear 1. The input shaft 15 operatively supports the eccentric mechanism 17 which is eccentric from the input shaft 15 by a design value. The regulation mechanism 20 fixes the eccentric mechanism 17 to the input shaft 15 with any desired amount of eccentricity. As shown in FIGS. 2A to 2C, the regulation mechanism 20 fixes the amount of eccentricity in any position so that the position of the inner circumference external tooth gear 11 with respect to the outer circumference internal tooth gear 10, the pressure that is applied to the teeth, and the bending amount of the second tooth 18 are capable of being selectively regulated.

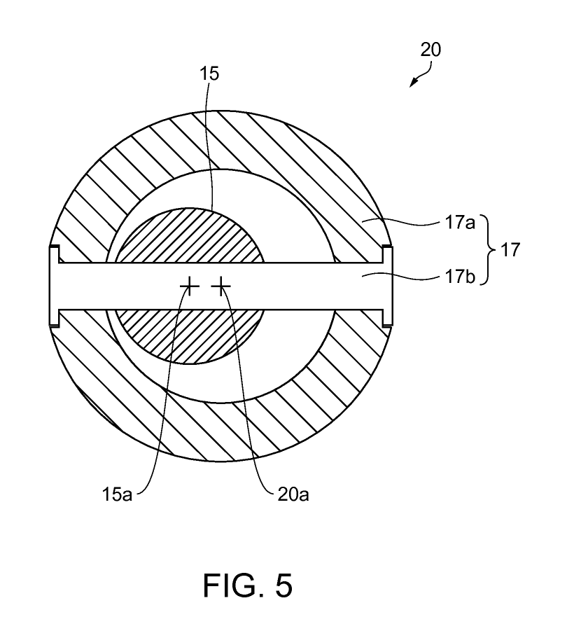

FIG. 5 is a schematic cross-sectional view illustrating a configuration of the regulation mechanism 20. The regulation mechanism 20 includes the eccentric mechanism 17, and the eccentric mechanism 17 includes a cylindrical section 17a and a screw shaft section 17b. The cylindrical section 17a has a cylindrical shape and the input shaft 15 is arranged inside of the cylindrical section 17a. An axial direction of the cylindrical section 17a and an axial direction of the input shaft 15 are parallel to each other. The screw shaft section 17b has a column-shape and penetrates the cylindrical section 17a and the input shaft 15. The axial direction of the screw shaft section 17b is orthogonal to the axial direction of the cylindrical section 17a and the input shaft 15.

A threaded bore is formed in the input shaft 15 for engaging with the screw shaft section 17b. Thus, external threads are formed along the outer circumference of the screw shaft section 17b. Accordingly, a linear motion mechanism is formed by which the input shaft 15 moves to the left and right in the drawing by rotating the screw shaft section 17b. Thus, a distance between a center axis 15a of the input shaft 15 and a center axis 20a of the regulation mechanism 20 can be regulated by rotating the screw shaft section 17b.

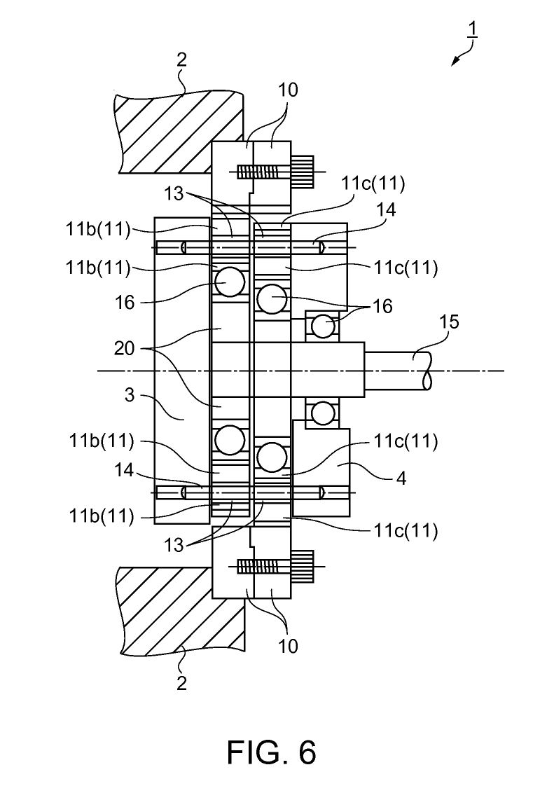

FIG. 6 is a schematic side cross-sectional view illustrating a configuration of the reduction gear. As shown in FIG. 6, the reduction gear 1 is disposed at a base 2 that has a hole for this use. The outer circumference internal tooth gear 10 is fixed to the base 2. A first inner circumference external tooth gear 11b and a second inner circumference external tooth gear 11c are disposed within the outer circumference internal tooth gear 10. The first inner circumference external tooth gear 11b and the second inner circumference external tooth gear 11c have the same shape as the inner circumference external tooth gear 11. However, the first inner circumference external tooth gear 11b and the second inner circumference external tooth gear 11c are offset from one another so that their shaft centers are vertically shifted or offset in the drawing. Thus, the first inner circumference external tooth gear 11b and the second inner circumference external tooth gear 11c press the outer circumference internal tooth gear 10 in the up and down directions.

The regulation mechanism 20 is disposed at the center side of each inner circumference external tooth gear 11 via bearing 16. Thus, the input shaft 15 is disposed within the regulation mechanism 20. A first support plate 3 and a second support plate 4 are disposed so as to pinch the inner circumference external tooth gear 11. The first support plate 3 and the second support plate 4 are fixed by the fixing pins 14 as the output transmission fixing pins. Accordingly, the first support plate 3 and the second support plate 4 do not relatively move. A gap is arranged and lubricant is provided between the first support plate 3, the first inner circumference external tooth gear 11b, the second inner circumference external tooth gear 11c and the second support plate 4 respectively. Accordingly, each member can move with little friction.

Return to FIG. 4, four output transmission holes 13 are formed in the inner circumference external tooth gear 11. The fixing pins 14 are disposed through all of the output transmission holes 13. Thus, the regulation mechanism 20 regulates the clearance between the fixing pins 14 and the output transmission holes 13. The amount of eccentricity of the center shaft of the inner circumference external tooth gear 11 and the input shaft 15 is also regulated by the regulation mechanism 20. Thus, when the amount of eccentricity is appropriate, the output transmission holes 13 and the fixing pins 14 come into contact with each other. Accordingly, the fixing pins 14 come into contact with all of the output transmission holes 13.

When the inner circumference external tooth gear 11 rotates, torque is transmitted to the fixing pins 14. Return to FIG. 6, the torque transmitted to the fixing pins 14 is transmitted to the first support plate 3 and the second support plate 4. Accordingly, the first support plate 3 and the second support plate 4 function as an output shaft.

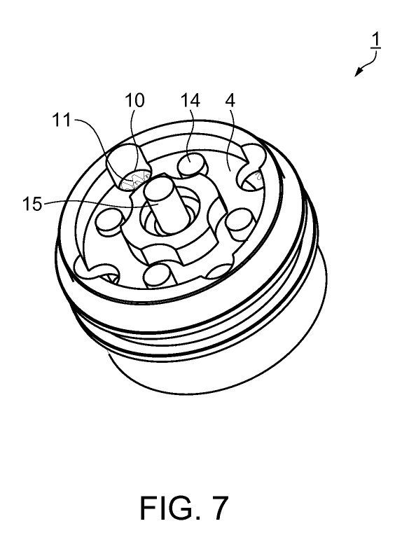

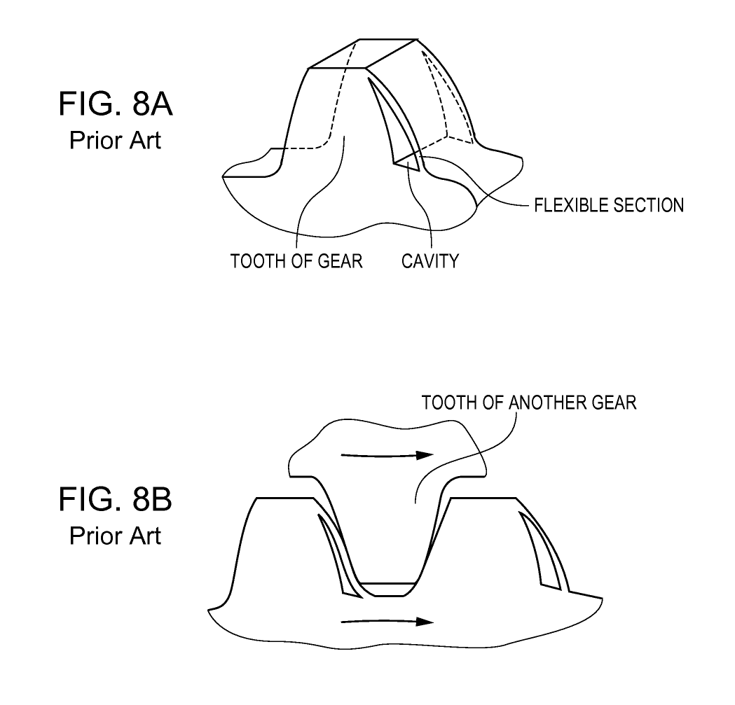

FIG. 7 is a schematic perspective view illustrating the cased reduction gear 1. As shown in FIG. 7, the outer circumference internal tooth gear 10 and the inner circumference external tooth gear 11 are disposed inside the reduction gear 1. Thus, the input shaft 15 rotates so that the second support plate 4 rotates with reduced speed.

According to the regulation mechanism 20, at least the following advantages can be obtained in addition to the advantages of the first embodiment. As shown in FIGS. 2A to 2C, since the pressure that is applied to the second tooth 18 and bending amount of the second tooth 18 can be selectively regulated, the variations of the dimensions of the parts are capable of being absorbed by the range of the regulation. In addition, as shown in FIG. 4, since the clearance between the output transmission holes 13 and the fixing pins 14 can be selectively regulated, backlash can be regulated. Further, since all of the fixing pins 14 are capable of contributing to the transmission of torque, rigidity is maintained.

The entire disclosure of Japanese Patent Application No. 2011-086073 filed Apr. 8, 2011 is expressly incorporated by reference herein.

What is claimed is:

1. A reduction gear comprising:
an outer circumference internal tooth gear having a first tooth; and
an inner circumference external tooth gear having a second tooth,
wherein the reduction gear relatively rotates while the first tooth and the second tooth engaged each other, and
at least one of the first tooth and the second tooth has an elastic structure inside the tooth and the tooth is elastically deformable.

2. The reduction gear according to claim 1,
wherein the inner circumference external tooth gear has an eccentric mechanism and the eccentric mechanism has a regulation mechanism regulating an amount of eccentricity that is a distance between a center of a first circumference along which the first tooth is arranged and a center of a second circumference along which the second tooth is arranged.

3. The reduction gear according to claim 2,
wherein the inner circumference external tooth gear has output transmission holes,
wherein the reduction gear has an output shaft where output transmission fixing pins that come into contact with the output transmission holes are arranged, and
wherein the regulation mechanism regulates a clearance between the output transmission fixing pins and the output transmission holes.

4. The reduction gear according to claim 3,
wherein all of the output transmission fixing pins come into contact with the output transmission holes.

5. A reduction gear that rotates while a first tooth of an outer circumference internal tooth gear engages a second tooth of an inner circumference external tooth gear,
wherein at least one of the first tooth and the second tooth has an interior elastic structure.

6. The reduction gear according to claim 5,
wherein the elastic structure comprises a notch in a portion of the at least one tooth.

7. The reduction gear according to claim 5,
wherein the elastic structure comprises a cavity inside the at least one tooth.

8. The reduction gear according to claim 5,
wherein the inner circumference external tooth gear has an eccentric mechanism and the eccentric mechanism has a regulation mechanism regulating an amount of eccentricity that is a distance between a center of a first circumference along which the first tooth is arranged and a center of a second circumference along which the second tooth is arranged.

9. The reduction gear according to claim 8,
wherein the inner circumference external tooth gear has output transmission holes,
wherein the reduction gear has an output shaft where output transmission fixing pins that come into contact with the output transmission holes are arranged, and
wherein the regulation mechanism regulates a clearance between the output transmission fixing pins and the output transmission holes.

10. The reduction gear according to claim 9,
wherein all of the output transmission fixing pins come into contact with the output transmission holes.

11. A reduction gear comprising:
an outer ring gear having internally projecting first teeth; and
an inner ring gear having externally projecting second teeth engaged with said first teeth,
at least one of the first and second teeth has an internal elastic structure so that the at least one tooth is elastically deformable.

12. The reduction gear according to claim 11,
further comprising a regulation mechanism regulating an eccentricity of the outer ring gear relative to the inner ring gear.

13. The reduction gear according to claim 11,
wherein the internal elastic structure comprises a notch in a tip portion of the at least one tooth.

14. The reduction gear according to claim 11,
wherein the internal elastic structure comprises a cavity inside the at least one tooth.
